(19) United States
(12) Patent Application Publication
(10) Pub. No.: US 2026/0154777 A1
(43) Pub. Date: Jun. 4, 2026

(54) GRAPHICS PROCESSING APPARATUS AND METHOD FOR PERFORMANCE METRIC SAMPLING

(71) Applicant: Arm Limited, Cambridge (GB)

(72) Inventors: Tord Kvestad ØYGARD, Kirkenes (NO); Ozgur TASDIZEN, Cambridge (GB); Nikunj Kaushik PATEL, Cambridge (GB)

(73) Assignee: Arm Limited, Cambridge (GB)

(21) Appl. No.: 19/404,253

(22) Filed: Dec. 1, 2025

(30) Foreign Application Priority Data
Dec. 3, 2024 (GB) 2417738.8

(51) Int. Cl. G06T 1/20; G06T 1/60

(52) U.S. Cl. CPC G06T 1/20; G06T 1/60

(57) ABSTRACT

A graphics processing apparatus includes a workload execution circuit to execute workloads and a performance counting circuit to count instances of performance metrics. A workload handling circuit receives commands and responds to performance counter sampling commands that indicate performance counter sampling contexts comprising performance metrics to be sampled and sampling intervals. The workload handling circuit monitors sampling intervals and triggers the workload execution circuit to write out sample values for performance metrics upon interval elapse. A driver receives performance metric sampling indications, allocates memory for sample values, generates performance counter sampling commands, and provides these to the workload handling circuit. The workload handling circuit writes out workload scheduling metadata, configures sampling according to sampling contexts, and manages the writing of sample values either directly to memory or back to the workload handling circuit with associated timestamp information.

### BACKGROUND

The present disclosure relates to graphics processing systems, and more particularly to monitoring performance metrics in a graphics processing apparatus.

Graphics processing is generally performed by first splitting a scene (e.g. a 3D model) to be displayed onto a number of similar basic components or “primitives”, which primitives are then subjected to the desired graphics processing operations. The graphics “primitives” are usually in the form of simple polygons, such as triangles.

Once primitives and their vertices have been generated and defined, they can be further processed by a fragment processing pipeline, in order to generate the desired graphics processing output (render output), such as a frame for display.

This usually involves determining which sampling points of an array of sampling points associated with the render output area to be processed are covered by a primitive, and then determining the appearance each sampling point should have (e.g. in terms of its colour) to represent the primitive at that sampling point. These processes are commonly referred to as rasterizing and rendering, respectively.

The rendering process involves deriving the data, such as red, green and blue (RGB) colour values and an “alpha” (transparency) value, necessary to represent the primitive at the sampling points. Where necessary, newly generated data may be blended with data that has previously been generated for the sampling point in question.

In tile-based rendering, the render output is divided into a plurality of smaller regions, herein referred to as “tiles”. Each tile is rendered separately and the rendered tiles are then recombined to provide the complete render output, e.g. a render pass or a frame to be displayed.

A tile-based graphics processing pipeline includes one or more so-called tile buffers that store rendered fragment data at the end of the pipeline until a given tile is completed and written out to an external memory, such as a frame buffer, for use. In some tile-based graphics processing pipelines, the rendered fragment data is compressed before being written out to the external memory.

A graphics processing apparatus may also be operable to perform other types of computation, such as general compute workloads or neural processing/machine learning workloads, in which case the apparatus may be operated in another suitable manner for such processing.

### BRIEF DESCRIPTION OF THE FIGURES

Examples of the present disclosure will now be described with reference to the accompanying drawings:

FIG. 1 is a schematic diagram showing a graphics processing system within a system on chip;

FIG. 2 is a flow diagram showing a method for processing graphics data in a graphics processing system;

FIG. 3 is a schematic diagram showing workload flow within a graphics processing apparatus;

FIG. 4 is a schematic diagram showing performance counting flows within a graphics processing apparatus;

FIG. 5 is a sequence diagram showing the collection of performance counting data;

FIG. 6 is a schematic diagram showing a region of memory allocated for performance counting;

FIG. 7 is a schematic diagram showing tile-based processing of a render output;

FIG. 8 is a scheduling diagram showing timing relationships between workload processing tasks and sampling intervals;

FIG. 9 is a schematic diagram showing a structure for a performance counter sample, performance counter metadata and workload scheduling metadata; and

FIG. 10 is a schematic diagram showing a simulator implementation within a host data processing apparatus.

### DETAILED DESCRIPTION

In one example arrangement, there is provided a graphics processing apparatus comprising: workload execution circuitry/circuit to execute workloads within the graphics processing apparatus, the workload execution circuitry/circuit comprising performance counting circuitry/circuit to count instances of one or more performance metrics; workload handling circuitry/circuit to receive commands, wherein the workload handling circuitry/circuit is responsive to commands indicative of a workload to execute to cause the workload to be executed on the workload execution circuitry/circuit; wherein the workload handling circuitry/circuit is responsive to a performance counter sampling command indicative of at least one performance counter sampling context comprising at least one performance metric to be sampled and a sampling interval at which the at least one performance metric is to be sampled, to configure the workload handling circuitry/circuit for sampling according to the at least one performance counter sampling context; wherein for each configured performance counter sampling context, the workload handling circuitry/circuit is to monitor the sampling interval, and on elapse of the sampling interval: trigger the workload execution circuitry/circuit to write out a sample value for the at least one performance metric.

In another example arrangement, there is provided a method of operating a graphics processing apparatus comprising: receiving, at workload handling circuitry/circuit, commands indicative of a workload to execute; causing the workload to be executed on workload execution circuitry/circuit; configuring, by the workload handling circuitry/circuit responsive to a performance counter sampling command indicative of at least one performance counter sampling context comprising at least one performance metric to be sampled and a sampling interval at which the performance metric is to be sampled, the workload handling circuitry/circuit for sampling according to the at least one performance counter sampling context; for each configured performance counter sampling context, monitoring, by the workload handling circuitry/circuit, the sampling interval, and on elapse of the sampling interval: triggering the workload execution circuitry/circuit to write out a sample value for the at least one performance metric.

In a further example arrangement, there is provided a method of controlling a graphics processing apparatus comprising: receiving an indication of at least one performance metric to be sampled and at least one sampling interval at which to sample the at least one performance metric; allocating a region of memory for sample values to be stored; generating, based on the indication, a performance counter sampling command comprising at least one performance counter sampling context, the at least one performance counter sampling context comprising at least one performance metric to be sampled and a sampling metric at which the at least one performance metric is to be sampled; and providing the performance counter sampling command to the graphics processing apparatus.

In a yet further example arrangement, there is provided a computer program for controlling a host data processing apparatus to provide an instruction execution environment for execution of target commands, the computer program comprising: workload execution program logic to execute workloads, the workload execution program logic comprising performance counting program logic to count instances of one or more performance metrics; workload handling program logic to receive commands, wherein the workload handling program logic is responsive to commands indicative of a workload to execute to cause the workload to be executed on the workload execution program logic; wherein the workload handling program logic is responsive to a performance counter sampling command indicative of at least one performance counter sampling context comprising at least one performance metric to be sampled and a sampling interval at which the at least one performance metric is to be sampled, to configure the workload handling program logic for sampling according to the at least one performance counter sampling context; wherein for each configured performance counter sampling context, the workload handling program logic is to monitor the sampling interval, and on elapse of the sampling interval: trigger the workload execution program logic to write out a sample value for the at least one performance metric.

A graphics processing apparatus may have performance counting circuitry/circuits with performance counters to count the incidence of various types of performance events associated with the workloads executing on the apparatus. This information can be used by application developers to improve the performance of their workloads by providing greater insight about how the workloads are executing on the apparatus. For example, the performance metric information can be used to identify portions of the workload that are most in need of optimisation (e.g., because they consume more processing resources) or to measure the effect of changes to the workload on the processing efficiency.

Each performance counter is associated with a particular type of event (e.g., a cache miss, processing of a primitive, etc) and is arranged to increment its counter when the particular event occurs during execution of a workload. These counter values can then be sampled to collect the counter values at a particular time, with that information used to analyse the execution of workload.

One approach to collecting such samples is to use software running on a host data processing device (e.g., a driver on a central processing unit) to drive the collection of samples. This involves monitoring of a sampling interval by the driver and, when the interval elapses, sending a command to the graphics processing apparatus to capture the values currently held by the performance counters.

With this approach, the rate at which performance sampling can be carried out is limited by the CPU's ability to trigger samples. As the sample rate is increased, this interferes with the application running on the CPU which needs to be repeatedly interrupted in order to trigger the collection of samples. In an illustrative example, a graphics processor may operate to render a game at 60 frames per second with the CPU able to support sampling 1 kHz, thereby providing about 16 performance counter samples per frame. However, the rendering of each frame of a high-end game may comprises 50-100 individual workloads to composite that frame. With this approach therefore, the application developer's ability to examine the individual workloads is limited.

One approach to addressing this issue is to serialise the workloads by inserting sleeps between the workloads, maintaining the sampling at 1 kHz but allowing for more granularity in the data collected for each workload. While this approach provides additional insight into the workloads, it has a significant performance impact and less insight can be obtained into the timing of the workload execution.

In accordance with the techniques described herein, there is therefore provided a graphic processing apparatus able to perform GPU-driven performance counter sampling, whereby collection of the samples is triggered by the GPU itself rather than by the CPU.

By adopting this approach, it is possible to support performance counters at a higher rate than using a CPU-driven model. Moreover, by moving the sample trigger closer to the performance counters themselves, the latency between a sample being triggered and the performance counter values being collected can be reduced and the occurrence of missed samples where the CPU was busy at the elapse of the sampling interval and hence unavailable to trigger sample collection can be reduced.

As described in detail herein, the driver, in response to its own configuration (e.g., via an application programmatic interface (API)) is able to configure a performance counter sampling context on the GPU by providing a command to the GPU. This performance counter sampling command specifies at least one performance metric to be sampled (e.g., a number of cache misses or primitives processed) and a sampling interval at which the sampling is to be carried out. The GPU is then able to monitor that sampling interval and trigger the write-out of sample values itself, without further input from the CPU.

Thus, in accordance with the present disclosure, there is provided a graphics processing apparatus that includes workload execution circuitry/circuit configured to execute workloads and perform performance counting of various performance metrics. The workload handling circuitry/circuit receives commands and responds to commands indicating workloads to be executed by causing their execution on the workload execution circuitry/circuit. The workload handling circuitry/circuit can be configured for performance counting through performance counter sampling commands that specify performance counter sampling contexts, where each context defines performance metrics to be sampled and associated sampling intervals.

For each configured performance counter sampling context, the workload handling circuitry/circuit monitors the specified sampling interval. When a sampling interval elapses, the workload handling circuitry/circuit triggers the workload execution circuitry/circuit to write out sample values for the specified performance metrics. The sample values may be written to a memory system associated with the apparatus. In some implementations, when triggering the workload execution circuitry/circuit, the workload handling circuitry/circuit provides an indication of a specific memory location where the sample value should be written. The workload execution circuitry/circuit then writes the sample value to that indicated memory location.

Where the sample value is written directly to the memory system by the workload execution circuitry/circuit, this simplifies the role of the workload handling circuitry/circuit and reduces traffic on the job control bus between the workload handling circuitry/circuit and the workload execution circuitry/circuit.

It will be appreciated that the memory system may take a number of possible forms; however, in some examples, the memory system comprises main memory and a cache hierarchy. The graphics processing apparatus may thus contain a portion of the cache hierarchy, for example in the form of one or more load/store caches within the workload execution circuitry/circuit which are able to communicate with the wider memory system.

The performance counter sampling command may specify a memory region where samples should be stored. The workload handling circuitry/circuit controls the writing of sample values according to this specified memory region. When triggering the workload execution circuitry/circuit to write out sample values, the workload handling circuitry/circuit may provide specific sample memory locations within the designated memory region where the values should be written.

When a sampling interval elapses, the workload handling circuitry/circuit may additionally write out performance sampling metadata that includes timestamp information for the sampling interval.

The inclusion of this timestamp may help to correlate the various samples and by providing to the workload execution circuitry/circuit and indication of the memory location to which it is to write a given sample, the memory management can be handled by the workload handling circuitry/circuit, thus reducing the load on the CPU (which may otherwise be tasked with this function) while avoiding conflict between samples targeting the same memory location.

On the other hand, in some configurations, the workload execution circuitry/circuit provides sample values to the workload handling circuitry/circuit, which then writes these values to the associated memory system. The workload handling circuitry/circuit may aggregate multiple sample values received from the workload execution circuitry/circuit before writing an aggregated sample value to the memory system.

This alternative approach allows reduces the extent of modification required to the workload execution circuitry/circuit in order to support this scheme of performance counting since the workload execution circuitry/circuit does not need to be configured for writing out the samples to memory and also allows the workload handling circuitry/circuit to aggregate samples from across a range of instances of workload execution circuitry/circuit and only write-out the aggregated values (e.g., a total value summed across multiple samples), thereby reducing the amount of memory occupied for sampling.

When the workload handling circuitry/circuit causes a workload to be executed on the workload execution circuitry/circuit, it may write out workload scheduling metadata that includes both an indication of which workload is being executed and a corresponding timestamp.

This approach enables the workload being executed at a given time to be correlated with the performance counter values collected at that point (when those counter values are themselves associated with a timestamp) providing a lightweight way to attribute performance counter values to particular workloads. In general, it may not be attractive to include within the performance counter sample, a workload identifier since it may not be possible certain types of workload (e.g., vertex processing workloads) to ensure that a bounded number of workloads are simultaneously executed for a given draw call/renderpass.

The workload execution circuitry/circuit can include multiple endpoints that can receive workloads from the workload handling circuitry/circuit. When a sampling interval elapses for a particular performance counter sampling context, the workload handling circuitry/circuit identifies which endpoints should have their performance metrics sampled. The triggering of sample value write-outs is then directed specifically to these identified endpoints. These endpoints may be heterogeneous with the workload execution circuitry/circuit able to direct sampling only to those endpoints that are suitable for collecting the given type of performance counter.

When responding to a performance counter sampling command, the workload handling circuitry/circuit configures the workload execution circuitry/circuit by providing information about which performance metrics should be sampled. Upon receiving this indication, the workload execution circuitry/circuit instructs its performance counting circuitry/circuit to count instances of the specified performance metrics.

When configuring the workload execution circuitry/circuit in response to a performance counter sampling command, the workload handling circuitry/circuit can identify specific endpoints targeted by the performance counter sampling context. The workload handling circuitry/circuit then selectively activates performance counting for only those identified endpoints.

Thus, the workload handling circuitry/circuit can ensure that only the relevant performance counting circuitry/circuit is enabled, allowing performance counting circuitry/circuit that is not monitored to be disabled.

Additionally, it may be desirable to record which endpoints are active at a given time and so the workload handling circuitry/circuit may write out information that indicates which endpoints are active during workload execution. This information can then be used to account for which endpoints are active when it comes to analysing the performance counter data. The information may take the form of a mask indicating the active/inactive endpoints and could be provided at the start and end of execution and/or when an endpoint is activated/deactivated.

In some examples however, the memory region for storing samples could be zeroed-out by the driver before sample collection begins, with the presence or absence of samples used to infer whether a particular endpoint associated with a portion of a memory region was active or not.

In some instances, it may be desirable to collect performance counter data that is attributable to a particular draw call. The graphics processing apparatus can execute multiple draw calls that form a renderpass. The apparatus may be operable (e.g., based on a control field in the performance counter sampling command) to serialise the execution of these draw calls, restricting the workload execution circuitry/circuit or a portion of it to process only one draw call at any given time. Thus, the application developer can separately analyse the execution of a given draw call.

For some workloads (e.g., vertex processing workloads), this serialisation may be achievable without substantial modification to the graphics processing apparatus; however, in a tile-based graphics processing apparatus, serialisation of fragment processing workloads in particular may be more complicated, as explained below.

A tile-based graphics processing apparatus divides render output into multiple tiles and executes rendering workloads for each tile asynchronously. It is therefore be difficult to serialise the execution of the draw calls (or where a draw call is executed multiple times, instances of the draw call) across the asynchronously processed tiles.

In accordance with the techniques described herein however, in the context of executing fragment shading for draw calls within a renderpass, the workload execution circuitry/circuit can serialise the execution of rendering workloads by ensuring that workloads associated with a subsequent draw call do not begin until the workloads for the previous draw call are completed.

Further, to capture the performance counters on a per-draw call or per-instance basis, the workload execution circuitry/circuit may trigger the writing of performance metric sample values at execution boundaries between draw calls or draw call instances.

When writing out sample values, the workload execution circuitry/circuit may include workload identifying information. This identifying information may comprise various elements such as draw call identifiers, draw call instance identifiers, command identifiers, or tile coordinates to provide further insight to the application developer about what was executing at the time the performance counter sample was collected. The suitability to collect this information may vary depending on the type of workload being executed since, as explained above, for vertex processing workloads for example, it may not be possible to constrain the number of command identifiers needed, whereas for fragment processing workloads a single command may be used to trigger the entire fragment shading process for a given draw call. By including tile coordinates in the sample information, performance metrics can be associated with regions of the render output, e.g., to produce a heatmap of execution complexity based on screen location per draw call. Such heatmap information can provide useful insight to application developers and is otherwise difficult to obtain without the use of the present techniques.

Although these techniques are applicable to a graphic processing apparatus, it should be recognised that the workload execution circuitry/circuit may be able to handle various types of workloads, which may include texturing workloads, fragment shading workloads, geometry processing workloads, compute workloads, and neural processing workloads.

The performance counting circuitry/circuit may be able to count various performance metrics, including cache misses, processed primitives, rendered fragments, specific operation types, machine learning acceleration tasks, computer tasks, and active cycles of workload execution circuitry/circuit elements. It should be appreciated that the examples given here represent some of the possible metrics that could be monitored but that many more or different possible metrics may be used.

The performance monitoring commands may be received from a host processing apparatus that communicates with the graphics processing apparatus.

A method of operating the graphics processing apparatus involves the workload handling circuitry/circuit receiving commands that indicate workloads to execute. The workload handling circuitry/circuit causes these workloads to be executed on the workload execution circuitry/circuit. When receiving a performance counter sampling command, the workload handling circuitry/circuit configures itself according to the specified performance counter sampling contexts, which define performance metrics and their sampling intervals. For each configured context, the workload handling circuitry/circuit monitors the sampling interval and triggers the workload execution circuitry/circuit to write out sample values when intervals elapse.

A method of controlling the graphics processing apparatus includes receiving indications of performance metrics and sampling intervals, allocating memory regions for storing sample values, and generating performance counter sampling commands. These commands specify performance counter sampling contexts that include the metrics to be sampled and their sampling intervals. The commands are then provided to the graphics processing apparatus.

A computer program can provide an instruction execution environment for target commands through workload execution program logic that includes performance counting capabilities. The program includes workload handling logic that receives and processes commands for workload execution. This logic responds to performance counter sampling commands by configuring counter sampling contexts with specified metrics and intervals. The program monitors these intervals and triggers the writing of sample values when intervals elapse.

Subject to the particular operation in the manner of the technology described herein, the graphics processor and graphics processing apparatus can otherwise operate in any suitable and desired manner, for example, and in an embodiment, in the normal manner for the graphics processor and graphics processing apparatus in question.

Correspondingly, as well as the particular elements, stages, circuits, etc., described above with particular reference to the operation in the manner of the technology described herein, the graphics processor and graphics processing apparatus may otherwise include any suitable and desired elements, circuits, processing stages, etc., that a graphics processor and graphics processing apparatus may normally comprise.

It will furthermore be appreciated that the graphics processing apparatus of the technology described herein may be part of an overall graphics processing system that includes, e.g., and in an embodiment, a host processor (e.g. CPU) that, e.g., executes applications that require (graphics) processing by the graphics processing apparatus. The host processor will send appropriate commands and data to the graphics processing apparatus to control it to perform graphics processing operations and to produce graphics processing output required by applications executing on the host processor. To facilitate this, the host processor should, and in an embodiment does, also execute a driver for the graphics processor. The host processor may also execute a compiler or compilers for compiling programs to be executed by (e.g., a programmable processing stage (shader) of the) graphics processor.

The graphics processor and graphics processing apparatus may also comprise, and/or be in communication with, one or more memories and/or memory devices that store the data described herein, and/or the output data generated by the graphics processing apparatus, and/or store software (e.g. programs) for performing the processes described herein. The graphics processing apparatus may also be in communication with a host microprocessor, and/or with a display for displaying images based on the data generated by the graphics processing apparatus.

The technology described herein can be implemented in any suitable system, such as a suitably operable micro-processor based system. In some embodiments, the technology described herein is implemented in a computer and/or micro-processor based system.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry/circuit of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor and graphics processing apparatus can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

### System Components and Interconnections

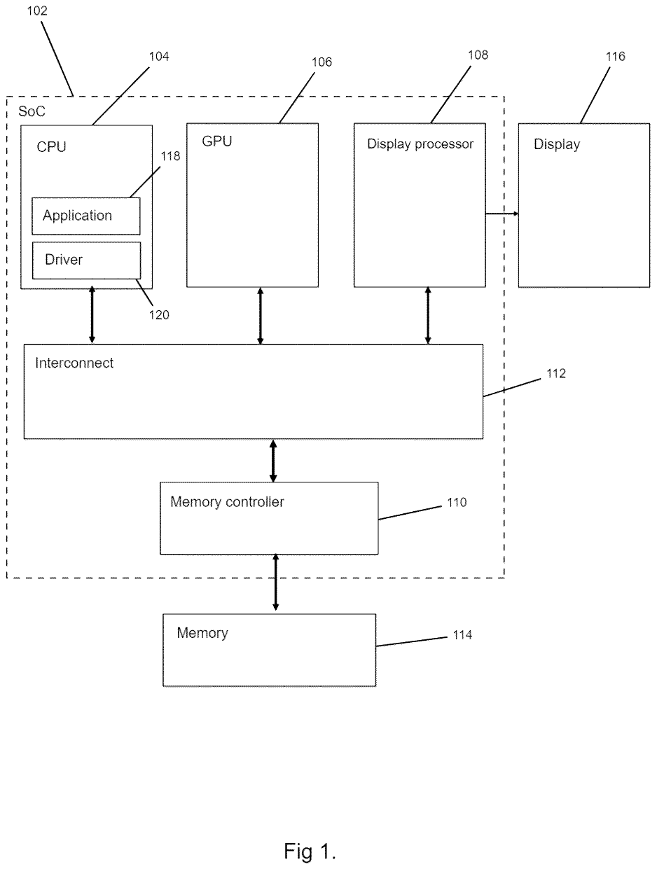

FIG. 1 shows a schematic diagram of a graphics processing system implemented within a system on chip 102. The system includes a host data processing apparatus 104 in the form of a central processing unit (CPU), a graphics processing apparatus 106 depicted as a graphics processing unit (GPU), a display processor 108, and a memory controller 110. These components communicate via an interconnect 112 and have access to memory 114.

The graphics processing apparatus 106 renders frames for display, while the display processor 108 provides these frames to a display 116 for presentation. During operation, an application 118, such as a game executing on the host data processing apparatus 104, generates requirements for frame display. The application 118 submits commands and data to a driver 120 associated with the graphics processing apparatus 106. The driver 120 executes on the host data processing apparatus 104 and generates appropriate commands and data to control the graphics processing apparatus 106.

In response to these commands, the graphics processing apparatus 106 renders frames and stores them in frame buffers within memory 114. The memory controller 110 manages access to the memory 114, coordinating data transfer between the various system components. The display processor 108 reads the rendered frames from memory 114 into a display buffer, from where they are subsequently read out and presented on the display 116.

### Graphics Processing Method Overview

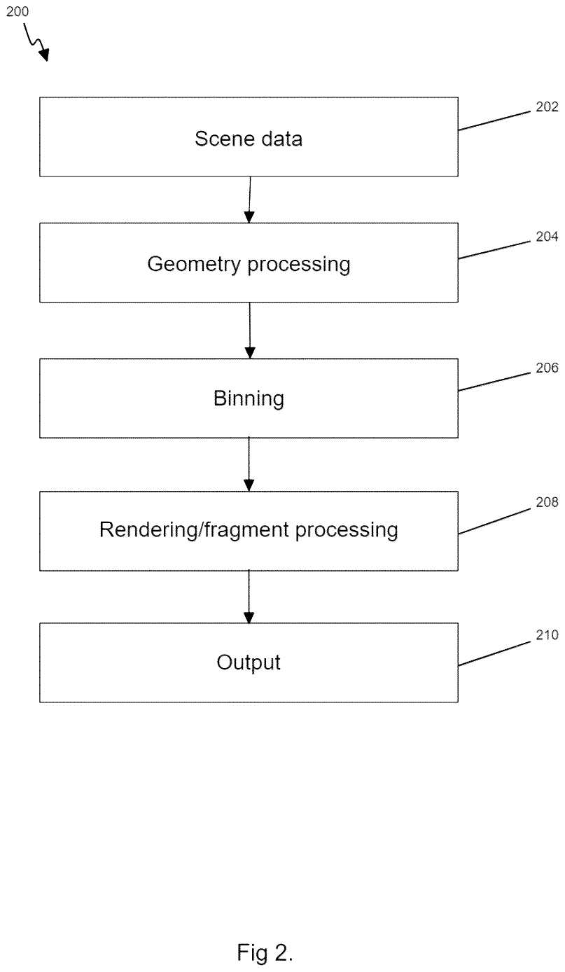

FIG. 2 shows schematically a method 200 for processing graphics data in a graphics processing system. The method 200 illustrates the processing sequence executed when generating an output 210. While the main elements and pipeline stages are shown, there may be other elements of processing that are not illustrated. The stages shown may share hardware circuits in practice, even though they are shown as separate stages. Each stage comprises appropriate circuitry and processing logic for performing the necessary operations and functions.

FIG. 2 illustrates a graphics processing pipeline within a tile-based graphics processor for which regions of the render output are divided into tiles with the rendering/fragment processing for each tile performed independently of the other tiles. The pipeline thus includes a binning stage 206 in which the processed geometry is sorted into tiles. However, it will be appreciated that other graphics processing pipelines which are not tile-based may vary.

A set of scene data 202 is provided, including vertices with associated attributes (such as positions and colours), indices referencing the vertices, and primitive configuration information indicating how the vertex indices are to be assembled into primitives. This scene data 202 may be provided by an application and/or driver, and may comprise complete sets of vertices and indices for the output, or different sets for respective draw calls.

Geometry processing 204 performs appropriate processing of the scene data 202 to generate data required for rendering. This includes vertex processing of attributes for vertices, particularly vertex position shading to transform positions from model space to screen space. The geometry processing 204 may also process other non-position attributes of vertices. Additional geometry processing operations may include tessellation shading, transform feedback shading, mesh shading, or task shading, which can generate and process attributes for both vertices and primitives.

A binning stage 206 follows the geometry processing 204. This stage operates in tile-based graphics processing systems to generate data structures that determine which primitives need processing for respective rendering tiles of the output. The binning 206 may sort primitives into lists indicating which primitives to process for respective tiles, or generate other structures such as hierarchies of bounding boxes. The binning stage 206 may also perform primitive culling for non-visible primitives.

Primitive assembly occurs during geometry processing 204 and/or binning 206. Primitives are assembled from indices referencing vertices based on primitive configuration information. This assembly may occur at various stages, potentially including multiple assembly operations—for example, an initial operation to identify vertices needed before vertex shading, and a later operation providing assembled primitives for binning.

Rendering/fragment processing 208 follows, performed on a tile-by-tile basis using the data structures from binning 206. This processing 208 may include rasterising primitives to fragments and performing fragment shading, or ray tracing operations for respective fragments representing sampling positions. Hybrid ray tracing operations are also possible.

The processed fragments are written to a tile buffer, and once processing for each tile completes, the tile is written to an output data array in memory. This continues until the complete output 210 is generated. The output 210 may be an image frame for display, intermediate render data for later rendering passes, or data for deferred rendering or hybrid ray tracing.

### Graphics Processing Apparatus Architecture

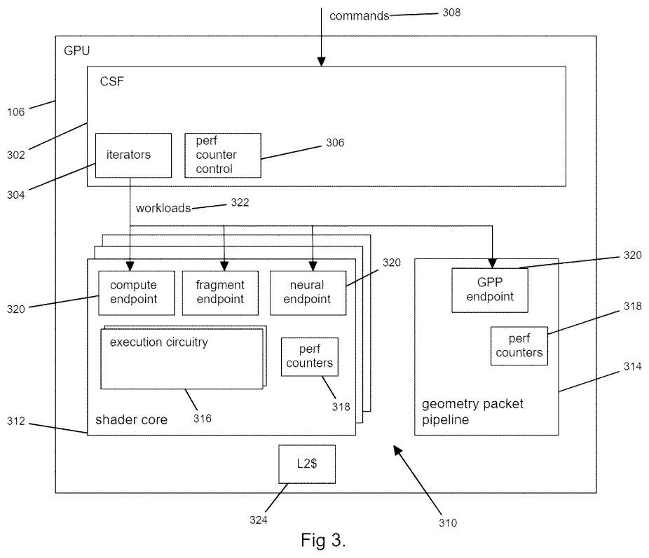

FIG. 3 elaborates on the graphics processing apparatus 106 shown in FIG. 1, illustrating the flow of workloads within the graphics processing unit. The graphics processing apparatus 106 comprises workload handling circuitry 302 and workload execution circuitry 310.

The workload handling circuitry 302 takes the form of a command stream frontend (CSF) that handles commands 308 received from the CPU. These commands 308 define the workloads to be executed by the graphics processing apparatus. The workload handling circuitry 302 includes iterators 304 and performance counter control circuitry 306. The iterators 304 schedule and dispatch workloads 322 to the execution circuitry 316, and may write out workload scheduling data with an indication of the workload being executed and a timestamp. The timestamp can be synchronised across the entire system, allowing correlation between application events on the CPU and events in the GPU. When performance counter samples are also associated with a timestamp, the samples can thus be correlated with the workload that was executing at the time the sample was collected. This can help developers identify and optimise specific parts of their code by establishing characteristics of particular workloads.

The workload execution circuitry 310 comprises a geometry packet pipeline 314 and a plurality of shader cores 312. The geometry packet pipeline 314, which has its own endpoint, performs geometry processing workloads. Each shader core 312 comprises execution circuitry 316 and endpoints 320 for different types of workloads. The shader cores 312 perform various types of workloads, including compute, fragment processing, and machine learning workloads.

The execution circuitry 316 is heterogeneous, with different elements for executing different types of workloads 322. These workloads may include texturing workloads, fragment shading workloads, geometry processing workloads, compute workloads, and neural processing workloads. The shader core 312 and the geometry packet pipeline 314 each contain performance counting circuitry 318 that counts various types of metrics associated with the executing workloads. These metrics may include cache misses encountered, primitives processed, fragments rendered, particular types of operations performed, tasks executed by machine learning acceleration circuitry, computer tasks executed, and cycles a given element of the workload execution circuitry has been active. The metrics counted by the performance counting circuitry 318 may vary depending on the type of circuitry in which it is situated.

The performance counter control circuitry 306 controls performance counting within the graphics processing apparatus and is responsible for triggering samples. The memory system includes a level 2 (L2) cache as shown in the figure, while additional memory system components may be situated in the wider system as illustrated in FIG. 1.

### Performance Counter Monitoring Architecture

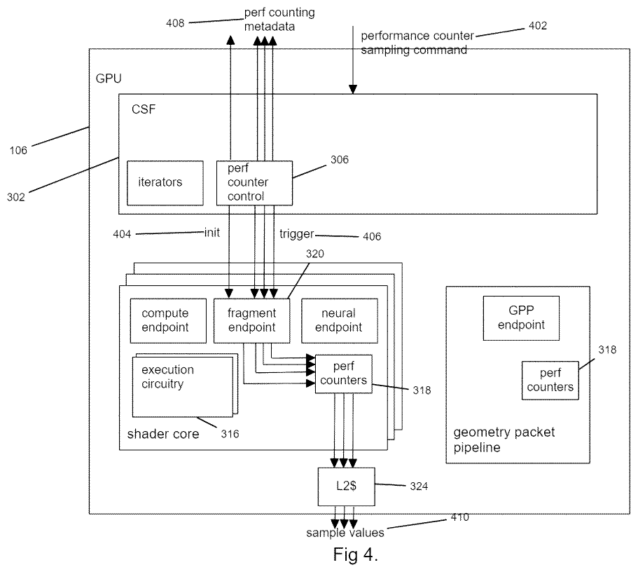

FIG. 4 elaborates on the features of the graphics processing apparatus 106 shown in FIG. 3, with particular focus on the performance counting flows rather than workload flows. The graphics processing apparatus 106 receives a performance counter monitoring command 402 that contains at least one performance metric to be sampled and a sampling interval.

In response to the performance counter monitoring command 402, the workload handling circuitry 302 sets up a performance sampling monitoring context within the performance counter control circuitry 306. The workload handling circuitry 302 also provides configuration information 404 to the appropriate endpoints of plurality of endpoints 320 to configure them for sampling. This configuration information 404 contains an indication of the performance metrics to be sampled allowing the workload execution circuitry to enable only the performance counters for which sampling is required. At this point, the performance counter control circuitry 306 may write-out metadata that is applicable to entire sample including, for example, which counters were enabled and the sampling interval and information about the layout of samples in memory. Although not depicted in FIG. 4, additional metadata applicable to the sampling context may be written out as sampling for the sampling context concludes including information on, for example, how many samples were captured, which counters were enabled, and so on, and potentially endpoint masks

The shader core 312 includes performance counting circuitry 318 that operates in conjunction with the plurality of endpoints 320. For each sampling interval, the performance counter control circuitry 306 sends a trigger 406 to the endpoints 320, causing them to collect a sample value 410. The trigger 406 may include a memory location to which the sample value 410 should be written.

In the example of FIG. 4, only the triggers sent to the fragment endpoint 320 are shown; however, it should be appreciated that a similar scheme will apply for workloads provisioned on the other endpoints 320.

In response to the triggers 406, the endpoints cause the sample values 410 to be written out to the memory system via L2 cache 324 (e.g., to the memory locations provided by the performance counter control circuitry 306). As shown in FIG. 4, the fragment endpoint 320 notifies the execution circuitry 316 which controls the performance counting circuitry 318 to write-out the value of the relevant performance metric. Additionally, the workload handling circuitry 302 may write out per-sample performance sampling metadata 408 that includes timestamp information for the sampling interval. In some cases, and where suitable, this per-sample metadata may also contain command identifiers to identify the command associated with the executing workload and/or draw call identifiers, draw call instance identifiers and tile coordinates.

The performance counter monitoring command 402 may be received from a host processing apparatus that is in communication with the graphics processing apparatus 106. This allows external control and monitoring of the performance sampling process while maintaining efficient operation within the graphics processing apparatus 106.

The ability to specify memory locations by the workload handling circuitry for storing sample values enables flexible organisation of performance data in memory. Memory locations can be dynamically assigned based on the needs of the sampling operation. This approach helps prevent conflicts between different sampling operations.

The inclusion of timestamp information in the performance sampling metadata enables temporal analysis of the performance data and for the performance samples to be correlated with the workload. This correlation facilitates analysis of performance characteristics across different phases of workload execution.

### Host and Graphics Processing Apparatus Interactions

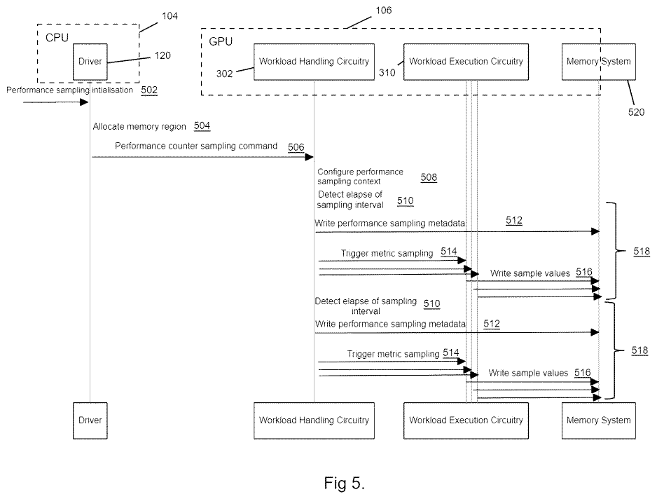

FIG. 5 illustrates a sequence diagram showing interactions between a host data processing apparatus 104 and a graphics processing apparatus 106. The graphics processing apparatus 106 includes workload handling circuitry 302, a plurality of instances of workload execution circuitry 310 and a portion of a memory system 520, such as a load store cache, while remaining portions of the memory system 520 may be located in the wider system.

A driver 120 receives a performance sampling initialisation message 502 from an application. In response to this initialisation, the driver 120 performs an allocation step 504 to designate a region in memory system 520 for storing sample values. At this point, the driver 120 may pre-clear the memory region by setting the value at each location to zero. The can help to simplify the determination of whether a valid sample has been recorded at a given memory region, since a non-zero value in the memory location would be indicative that a sample had been recorded. Otherwise, an endpoint mask generated by the graphics processing apparatus may need to be analysed to determine which endpoints were active (and hence able to produce valid samples) at any given time. The driver 120 then generates a performance counter sampling command 506 based on the received initialisation parameters.

The workload handling circuitry 302 receives the performance counter sampling command 506 and performs a configuration step 508 to set up performance counter sampling contexts. Each performance counter sampling context defines performance metrics to be sampled and associated sampling intervals 518 defining the rate at which the performance metrics should be sampled. The workload handling circuitry 302 monitors these sampling intervals 518, and upon detecting 510 an elapse 510, triggers subsequent sampling operations.

When a sampling interval elapses, the workload handling circuitry 302 writes performance sampling metadata 512 including timestamp information to the memory system 520. The workload handling circuitry 302 also sends a trigger message 514 to the workload execution circuitry 310 to initiate performance metric sampling. The workload execution circuitry 310 responds by writing sample values 516 for the requested performance metrics.

The sample values can be written out in a number of ways. In a first example approach, the workload execution circuitry 310 writes values directly to the memory system 520, which reduces modifications needed to support GPU-driven performance counting. This simplifies the role of the workload handling circuitry and avoids the need for large amounts of performance counting traffic on the job control bus between the workload handling circuitry and the workload execution circuitry. Alternatively, the workload execution circuitry 310 could return the sample values to the workload handling circuitry 302 for aggregation. This second approach enables accumulation from multiple endpoints before writing to memory, resulting in reduced memory usage.

The procedure to record the sample values is repeated for each sampling interval 518.

### Memory Allocation

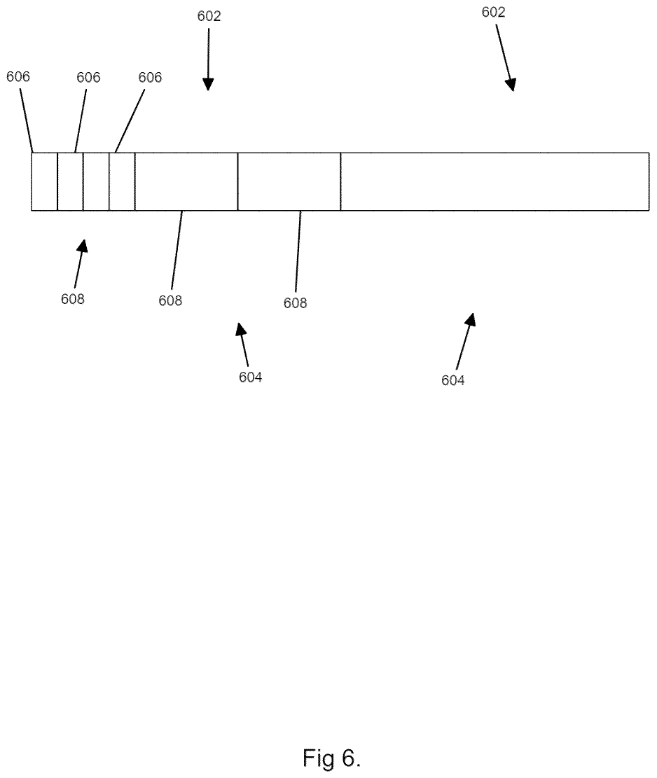

FIG. 6 is a schematic diagram showing a layout of memory allocated for performance sampling. The memory comprises multiple memory regions 602, each associated with a respective performance sampling counter context 604 as configured by the driver on the CPU.

Within each memory region 602, there is allocated a portion of memory 608 for each of a plurality of sampling intervals that contribute to a performance counter sampling context. FIG. 6 only breaks the sampling intervals for the first memory region 602. Each sampling interval 608 can include one or more memory locations 606, which are determined by the workload handling circuitry. A given sampling interval may have multiple memory locations 606 corresponding to different endpoints or performance metrics, with FIG. 6 showing the individual memory locations for the first sampling interval.

Thus, the memory given over to storing performance counter data can be separately allocated at a higher level by the driver (for the memory regions 602 corresponding to different performance counter sampling contexts) and at a lower level by the workload handling circuitry which is able to allocate within those memory regions, locations at which the individual sample values should be stored.

### Tile-Based Graphics Processing

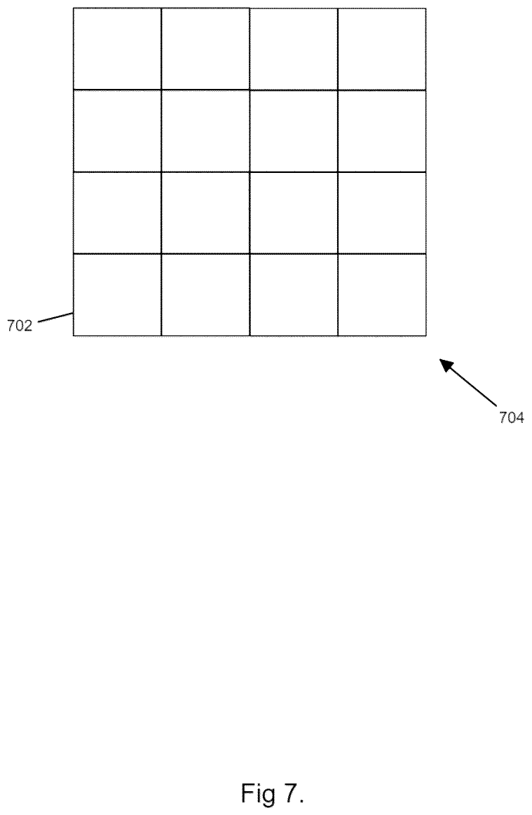

A graphics processing apparatus can operate as a tile-based graphics processor. FIG. 7 depicts the layout of tiles 702 within a render output produced by the tile-based graphics processing apparatus. In tile-based processing, a render output 704 produced by the graphics processing apparatus can be divided into a plurality of tiles 702. Each tile 702 represents a portion of the overall render output 704. The graphics processing apparatus can process these tiles 702 asynchronously, meaning that workloads associated with rendering different tiles can be executed independently and in parallel. This approach allows for efficient use of processing resources and can improve rendering performance. The size and arrangement of tiles 702 can vary depending on factors such as the resolution of the render output 704 and available processing resources.

### Workload Scheduling and Serialisation

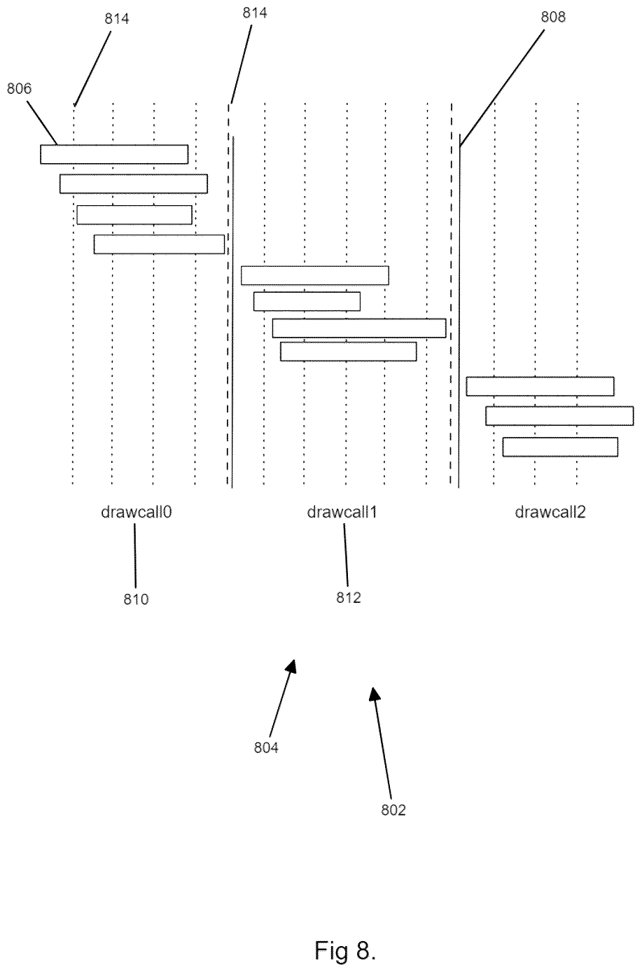

FIG. 8 shows a scheduling diagram illustrating timing relationships between workload processing tasks and sampling intervals. A renderpass 802 comprises a plurality of draw calls 804, where each draw call 804 contains multiple constituent workloads 806. As illustrated in FIG. 8, the workloads 806 have been serialized such that all workloads associated with a previous draw call 810 (or draw call instance) finish before a subsequent draw call 812 (or draw call instance) begins, thereby forming an execution boundary 808 between the draw calls. Serialization in this way has a significant impact on performance but and so may be a configurable option enabled/disabled using the performance sampling command.

For some types of workloads (e.g., geometry processing), this can be achieved relatively easily since the order in which the commands for the workloads are executed aligns with the draw call boundaries. However, for fragment processing within a tile-based graphics processor, each tile may be processed independently and so by default this per-draw call grouping is not respected. Thus to enable the serialisation as depicted, the execution circuitry executing the fragment workloads are arranged to identify, based on the draw call descriptors, when a subsequent draw call is to be executed, and stalls execution before beginning that draw call to ensure that execution of the previous draw call has completed

The scheduling arrangement allows the workload execution circuitry to operate on only one draw call at a given time. This serialization creates clear execution boundaries between draw calls, enabling precise performance metric sampling and attribution. When the sampling intervals 814 elapse (or when a boundary 808 is detected), sample values for designated performance metrics can be written out, providing accurate performance data associated with specific draw calls or portions thereof.

With the workload thus serialized, performance metrics can be sampled at sampling intervals 814, which may occur at the draw call boundaries and with additional samples at regular intervals within the draw call optional. By collecting performance metrics with the draw calls thus serialized, performance counters can be attributed to specific draw calls, providing enhanced insight for developers.

The ability to collect per-draw call performance metrics for fragment workloads enhances analysis capabilities. Performance counter data can be precisely associated with specific fragment processing operations within each draw call. This granular measurement enables detailed performance profiling of fragment workload execution.

### Performance Counter Sample, Performance Counter Metadata and Workload Scheduling Data Layout

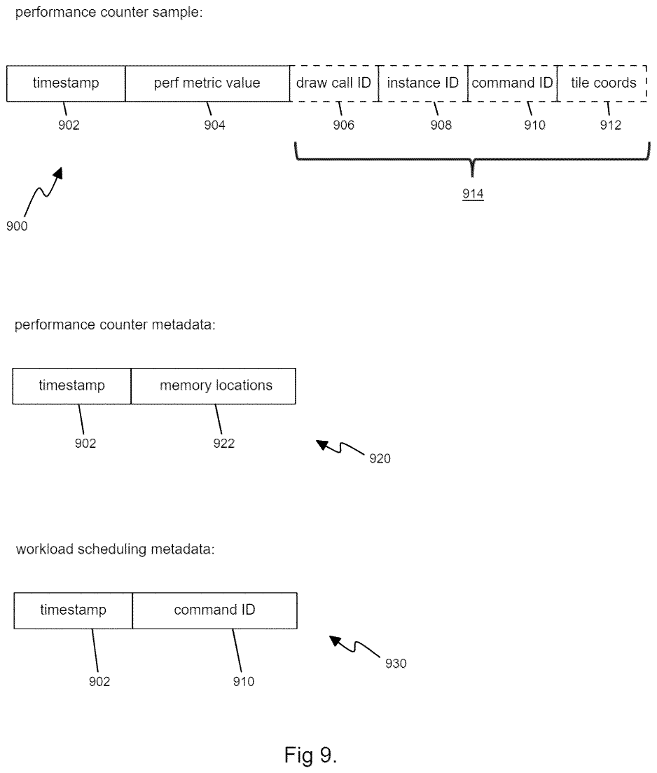

FIG. 9 illustrates example data structures for storing performance sampling data, performance counter samples, performance counter metadata, and workload scheduling data respectively.

A performance counter sample 900 comprises a timestamp 902 and a sample value 904. The sample value 904 indicates the value of the performance metric at the time the sample was taken. The timestamp 902 can be used to correlate samples with other events occurring at the same time as the sample, such as the workload that was executing or other samples.

Workload identifying information 914 can be included with the sample data. For fragment processing workloads, this may include a draw call identifier 906. In cases where draw calls are repeated in multiple instances, a draw call instance identifier 908 may be included to identify the specific instance of the draw call associated with the workload. A command identifier 910 identifies the workload, though this may not be suitable for inclusion for some types of workload. For example, in geometry processing workloads, the graphics processing apparatus may execute an unbounded number of workloads in a given renderpass, making it impractical to constrain the number of command identifiers. However, for fragment processing, command identifiers may be practical as each draw call within the fragment processing job may have its own command. Tile coordinates 912 can also be included, enabling the generation of a heatmap linking regions of render output to their associated performance metrics. FIG. 9 shows an example performance counter sample with only a single performance metric value. However, where a plurality of performance metrics are to be sampled for a given sampling interval, the performance counting circuitry may generate performance counting samples with a plurality of performance metric values corresponding to the different metrics to be monitored.

Performance sampling metadata 920 may be produced by workload handling circuitry and contains a timestamp and an indication of the memory locations 922 at which the associated sample values are stored.

Workload scheduling metadata 930 may be produced by an iterator and includes a timestamp and a command identifier. This metadata helps track the scheduling and execution of workloads within the graphics processing apparatus.

### Simulation Example

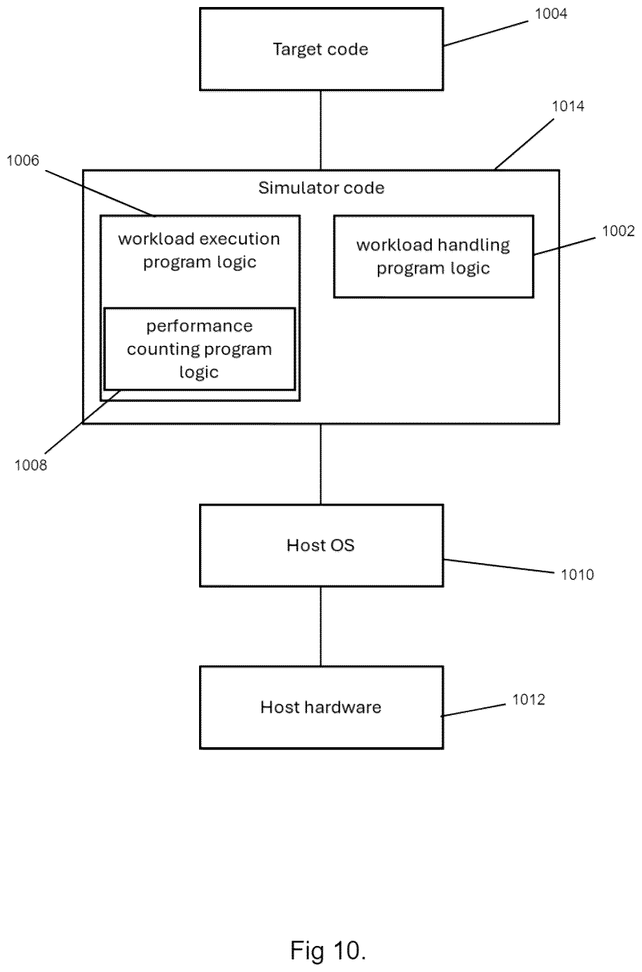

FIG. 10 illustrates a simulator implementation that may be used. Whilst the earlier described embodiments implement the present technology in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture.

A computer program 1014 controls a host data processing apparatus 1012 to provide an instruction execution environment for execution of target code 1004. The computer program 1014 includes workload execution program logic 1006 to execute workloads, with the workload execution program logic 1006 including performance counting program logic 1008 to count instances of one or more performance metrics.

The computer program 1014 also includes workload handling program logic 1002 to receive commands. When commands indicative of a workload to execute are received, the workload handling program logic 1002 causes the workload to be executed on the workload execution program logic 1006. The workload handling program logic 1002 responds to performance counter sampling commands that specify at least one performance counter sampling context. Each performance counter sampling context comprises at least one performance metric to be sampled and a sampling interval at which the performance metric is to be sampled.

Upon receiving a performance counter sampling command, the workload handling program logic 1002 configures itself for sampling according to the specified performance counter sampling context. For each configured performance counter sampling context, the workload handling program logic 1002 monitors the sampling interval. When the sampling interval elapses, the workload handling program logic 1002 triggers the workload execution program logic 1006 to write out a sample value for the specified performance metric.

The computer program 1014 may operate under a host OS 1010 running on the host data processing apparatus 1012. The host data processing apparatus 1012 can execute the target code 1004 within the instruction execution environment provided by the computer program 1014. This arrangement allows performance monitoring and sampling of workloads even when the underlying hardware may not directly support the desired performance monitoring capabilities.

The computer program 1014 can be implemented as a simulator, providing a software-based implementation of a hardware architecture. Various types of simulators can be used, including emulators, virtual machines, models, and binary translators. The simulation can involve multiple layers between the hardware and the instruction execution environment, or support multiple distinct instruction execution environments on the same host data processing apparatus 1012.

### Additional Variations

In some configurations, the workload handling circuitry 302 can aggregate multiple sample values 410 received from the workload execution circuitry 310 before writing an aggregated sample value to the memory system 324. This aggregation can help reduce memory bandwidth usage while still maintaining meaningful performance data.

The workload execution circuitry 310 can be configured to execute various types of workloads 322, including texturing workloads, fragment shading workloads, geometry processing workloads, compute workloads, and neural processing workloads. This flexibility allows the graphics processing apparatus 106 to handle diverse processing tasks efficiently.

The performance counting circuitry 318 can be configured to count different types of metrics depending on the specific requirements. These metrics may include the number of cache misses encountered, primitives processed, fragments rendered, particular types of operations performed, tasks executed by machine learning acceleration circuitry, computer tasks executed, and cycles during which given elements of the workload execution circuitry have been active.

Sample values 904 can be written out along with associated indications of the workload being executed on the workload execution circuitry 310 at the time of sampling. This correlation between sample values and workloads enables more detailed analysis of performance characteristics across different types of processing tasks.

The sampling intervals 814 can be configured to occur at drawcall boundaries and optionally at regular intervals. This approach provides flexibility in capturing performance data at both natural processing boundaries and at fixed time or event intervals.

Multiple memory locations 606 can be associated with a single sampling interval 608, corresponding to different endpoints or performance metrics. The workload handling circuitry 302 determines these memory locations and manages their allocation within the designated memory regions 602.

The performance sampling metadata 920 produced by the workload handling circuitry 302 can include timestamps and indications of memory locations where associated sample values are stored. This metadata facilitates temporal correlation of samples and enables efficient post-processing of collected performance data.

When configuring endpoints for sampling, the workload handling circuitry 302 can selectively activate performance counting circuitry 318 associated with specific identified endpoints. This selective activation allows for focused performance monitoring of particular system components while minimizing overhead.

The recording of memory location metadata enables tracing the flow of performance data through the system. The inclusion of memory location indicators in the performance sampling metadata allows reconstruction of the sampling history. This capability supports verification that data has been correctly captured and stored during the sampling process.

The transfer of sample values from the workload execution circuitry to the workload handling circuitry, followed by writing to the memory system, enables centralized management of performance data. The workload handling circuitry acts as a coordinated point for organizing and storing the collected sample values. This centralized approach allows for systematic tracking and analysis of performance metrics across the processing system.

The aggregation of multiple sample values into a single aggregated value before writing to memory provides data compression. The compressed data format reduces the amount of data that needs to be transferred between components and stored in memory. This approach maintains the ability to analyse performance characteristics while decreasing memory bandwidth consumption and storage requirements.

The workload handling circuitry can dynamically configure which performance metrics are sampled by providing appropriate indications to the workload execution circuitry. This configuration capability allows the performance monitoring parameters to be adapted based on specific analysis requirements. The workload execution circuitry responds to these indications by directing the performance counting circuitry to track the specified metrics, enabling flexible adjustment of monitoring focus during operation.

The selective activation of performance counting circuitry for specific identified endpoints enables targeted monitoring of particular system components. By focusing the performance counting on selected endpoints rather than collecting data across all endpoints, the system can reduce unnecessary data collection and processing overhead. This targeted approach helps maintain system efficiency while gathering the specific performance metrics needed for analysis.

The workload handling circuitry can maintain records indicating which endpoints are active during workload execution. This tracking of endpoint activity provides detailed insights into how system resources are utilised across different processing phases. The recorded endpoint activity information enables analysis of the sample data to determine which samples are expected to be valid based on the endpoints that were active at the time the samples were recorded. If an endpoint associated with the memory location was inactive at a time period associated with sampling for that memory location, it can be inferred that the sample value was not written by the endpoint and hence is not a valid sample.

The workload handling circuitry provides specific memory location indications when triggering sample value writes. This approach enables precise control over where each sample value is stored within designated memory regions. The controlled allocation of memory locations helps prevent data overlap and allows for efficient organisation of performance monitoring data.

The direct specification of sample memory locations supports optimized memory resource utilization. Memory regions can be structured to accommodate different types of sample values in an organised manner. This structured approach to memory allocation facilitates streamlined access and processing of the collected performance data.

The workload execution circuitry supports multiple types of processing operations, including texturing, fragment shading, geometry processing, compute operations and neural processing. This broad workload support enables comprehensive performance monitoring across different graphics processing tasks. The performance data can be collected and analysed across these varied workload types to understand processing behaviour under different usage scenarios.

The wide variety of countable performance metrics enables detailed monitoring across different aspects of system operation. The metrics span hardware-level events like cache misses, processing events like primitive and fragment counts, and higher-level metrics like task execution counts. This comprehensive coverage allows for thorough analysis of system behaviour and resource utilisation patterns during operation.

The association between sample values and workload execution information enables detailed analysis of performance characteristics for specific workload types. Performance data can be analysed in the context of the processing tasks that generated it. This contextual information allows for identification of performance patterns and behaviours across different categories of workloads.

Thus, there has been described an approach to implementing fast performance counters within a graphics processing apparatus by moving the responsibility for triggering sampling from the CPU to the GPU, reducing the involvement of the CPU in the collection of samples and enabling higher sampling rates and greater correlation between the performance counter samples and the workloads associated with them.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A graphics processing apparatus comprising:
a workload execution circuit to execute workloads within the graphics processing apparatus, the workload execution circuit comprising a performance counting circuit to count instances of one or more performance metrics; and
a workload handling circuit to receive commands, wherein the workload handling circuit is responsive to commands indicative of a workload to execute to cause the workload to be executed on the workload execution circuit;
wherein the workload handling circuit is responsive to a performance counter sampling command indicative of at least one performance counter sampling context comprising at least one performance metric to be sampled and a sampling interval at which the at least one performance metric is to be sampled, to configure the workload handling circuit for sampling according to the at least one performance counter sampling context;
wherein for each configured performance counter sampling context, the workload handling circuit is to monitor the sampling interval, and on elapse of the sampling interval:
trigger the workload execution circuit to write out a sample value for the at least one performance metric.

2. The apparatus according to claim 1, wherein the workload execution circuit is configured to write-out the sample value to a memory system associated with the apparatus.

3. The apparatus according to claim 2, wherein:
the workload handling circuit is configured to, when triggering the workload execution circuit, to provide an indication of a memory location at which to write the sample value; and
the workload execution circuit is responsive to the indication of the memory location to write out the sample value to the memory location.

4. The apparatus according to claim 1, wherein on elapse of the sampling interval, the workload handling circuit is additionally to write out performance sampling metadata comprising timestamp information for the sampling interval.

5. The apparatus according to any preceding claim 1, wherein:
the workload execution circuit is configured to provide the sample value to the workload handling circuit; and
the workload handling circuit is configured to write sample values to a memory system associated with the apparatus.

6. The apparatus according to claim 1, wherein the workload handling circuit is configured, when causing a workload to be executed on the workload execution circuit, to write out workload scheduling metadata comprising an indication of the workload being executed and a timestamp.

7. The apparatus according to claim 1, wherein:
the workload execution circuit comprises a plurality of endpoints to which the workload handling circuit is able to send workloads; and
the workload handling circuit is configured to, on elapse of the sampling interval for a given performance counter sampling context, identify one or more endpoints for which the at least one performance metric is to be sampled; and
triggering the workload execution circuit to write out sample values comprises triggering the identified one or more endpoints.

8. The apparatus according to claim 1, wherein:
the workload handling circuit is responsive to the performance counter sampling command to configure the workload execution circuit for sampling according to the at least one performance counter sampling context by providing an indication to the workload execution circuit of the performance metrics to be sampled; and
the workload execution circuit is responsive to the indication of the performance metrics to be sampled to cause the performance counting circuit to count instances of the indicated performance metrics.

9. The apparatus according to claim 7, wherein the workload handling circuit is configured to write out information indicative of which endpoints are active during execution of a workload.

10. The apparatus according to claim 1, wherein:
the performance counter sampling command provides an indication of a memory region at which samples are to be stored; and
the workload handling circuit is configured to control the writing out of sample values in accordance with the indication of the memory location.

11. The apparatus according to claim 1, wherein:
the graphics processing apparatus is operable to execute a plurality of draw calls forming a renderpass; and
the apparatus is operable to serialise the execution of the draw calls forming the renderpass to restrict the workload execution circuit or a portion thereof to operate on only one draw call at a given time.

12. The apparatus according to claim 1, wherein the graphics processing apparatus is a tile-based graphics processing apparatus configured to divide a render output produced by the apparatus into a plurality of tiles and execute workloads associated with rendering for each tile asynchronously.

13. The apparatus according to claim 1, wherein:
the graphics processing apparatus is operable to execute a plurality of draw calls forming a renderpass; and
the apparatus is operable to serialise the execution of the draw calls forming the renderpass to restrict the workload execution circuit or a portion thereof to operate on only one draw call at a given time;
the graphics processing apparatus is a tile-based graphics processing apparatus configured to divide a render output produced by the apparatus into a plurality of tiles and execute workloads associated with rendering for each tile asynchronously;
the workload execution circuit or portions thereof are operable to serialise the execution of rendering workloads for the draw calls forming the renderpass by preventing the execution of workloads associated with a subsequent draw call from starting until execution of workloads associated with a previous draw call have been completed; and
the workload execution circuit is operable to trigger the workload execution circuit to write out the sample value for the at least one performance metric at an execution boundary of a draw call or a draw call instance.

14. The apparatus according to claim 13, wherein the workload execution circuit is operable to write out, along with the sample values, workload identifying information.

15. The apparatus according to claim 1, wherein the workload execution circuit is operable to execute one or more of:
texturing workloads;
fragment shading workloads;
geometry processing workloads;
compute workloads; and
neural processing workloads.

16. The apparatus according to claim 1, wherein the performance counting circuit is configured to count at least one of:
a number of cache misses encountered;
a number of primitives processed;
a number of fragments rendered;
a number of a particular type of operation performed;
a number of tasks executed by a machine learning acceleration circuit;
a number of computer tasks executed; and
a number of cycles a given element of the workload execution circuit has been active.

17. The apparatus according to claim 1, wherein the performance monitoring command is received from a host processing apparatus in communication with the graphics processing apparatus.

18. A method of operating a graphics processing apparatus comprising:
receiving, at a workload handling circuit, commands indicative of a workload to execute;
causing the workload to be executed on a workload execution circuit;
configuring, by the workload handling circuit responsive to a performance counter sampling command indicative of at least one performance counter sampling context comprising at least one performance metric to be sampled and a sampling interval at which the performance metric is to be sampled, the workload handling circuit for sampling according to the at least one performance counter sampling context;
for each configured performance counter sampling context, monitoring, by the workload handling circuit, the sampling interval, and on elapse of the sampling interval:
triggering the workload execution circuit to write out a sample value for the at least one performance metric.

19. A method of controlling a graphics processing apparatus comprising:
receiving an indication of at least one performance metric to be sampled and at least one sampling interval at which to sample the at least one performance metric;
allocating a region of memory for sample values to be stored;
generating, based on the indication, a performance counter sampling command comprising at least one performance counter sampling context, the at least one performance counter sampling context comprising at least one performance metric to be sampled and a sampling metric at which the at least one performance metric is to be sampled; and
providing the performance counter sampling command to the graphics processing apparatus.

20. A non-transitory computer readable storage medium storing a computer program for controlling a host data processing apparatus to provide an instruction execution environment for execution of target commands, the computer program comprising:
workload execution program logic to execute workloads, the workload execution program logic comprising performance counting program logic to count instances of one or more performance metrics; and
workload handling program logic to receive commands, wherein the workload handling program logic is responsive to commands indicative of a workload to execute to cause the workload to be executed on the workload execution program logic;
wherein the workload handling program logic is responsive to a performance counter sampling command indicative of at least one performance counter sampling context comprising at least one performance metric to be sampled and a sampling interval at which the at least one performance metric is to be sampled, to configure the workload handling program logic for sampling according to the at least one performance counter sampling context;
wherein for each configured performance counter sampling context, the workload handling program logic is to monitor the sampling interval, and on elapse of the sampling interval:
trigger the workload execution program logic to write out a sample value for the at least one performance metric.
